(19) United States
(12) Patent Application Publication
(10) Pub. No.: US 2013/0168112 A1
(43) Pub. Date: Jul. 4, 2013

(54) Filtered Blower

(71) Applicants: Russell Brown, Fortson, GA (US); Jerry Monroe, Columbus, GA (US)

(72) Inventors: Russell Brown, Fortson, GA (US); Jerry Monroe, Columbus, GA (US)

(21) Appl. No.: 13/339,337

(22) Filed: Dec. 28, 2011

(51) Int. Cl. A62C 37/50

(52) U.S. Cl. 169/91

(57) ABSTRACT

A filtered blower for extinguishing candles on a dessert is provided. The filtered blower includes (1) a substantially tubular body having (a) a plurality of body sections adjoined to each other along their length to form a substantially hollow space, a mouthpiece, and a nozzle, (b) a raised lip surrounding the mouthpiece, and (c) a slot within the body, between the mouthpiece and nozzle, with a first portion and a second portion, wherein the first portion retains substantially unchanged dimensions, and the second portion narrows distally from the slot to the nozzle, and (2) a screen within the slot with holes sized for allowing passage of air while filtering passage of liquid and projectiles, whereby upon a person blowing air through the filtered blower, candles are extinguished while liquid and projectiles are prevented from reaching the dessert.

### CROSS-REFERENCE TO RELATED APPLICATIONS

Not Applicable

### BACKGROUND

1. Field of Invention

This invention pertains to devices for extinguishing birthday candles. More particularly, this invention pertains to devices for filtering air by a person blowing out candles on a birthday cake.

2. Description of the Related Art

One concern during birthday parties and other celebrations is preventing contamination of the desserts for those situations where the celebrant is required to blow out candles. For example, during birthday parties it is often the case that a child may be sick on their birthday. In such a circumstance the sick child may have a runny nose, a cough, or other less than sanitary conditions. It is sometimes the case that older celebrants may have less than full control of their faculties where blowing on a cake or other dessert is required.

It is often the case that the celebrant may produce spittle or other moisture while blowing out the candles. Other projectiles have also been known to leave a celebrant's mouth while blowing on the candles.

Heretofore, there have been less than desirable solutions for protecting the dessert that contains the candles, while also maintaining the dignity of the celebrant. For this reason a device is needed that protects a dessert from contamination while a celebrant blows out the candles on a birthday cake or other dessert.

### BRIEF SUMMARY

According to one embodiment of the present invention, a filtered blower for extinguishing candles on a dessert, such as a birthday cake, is provided. The filtered blower includes (1) a generally tubular body including (a) a mouthpiece with a first opening surrounded by a raised lip, (b) a nozzle having a second opening that is smaller than the first opening, and (c) a slot within the body between the mouthpiece and the nozzle, with a first portion and a second portion, wherein the first portion retains substantially unchanged dimensions, and the second portion narrows distally from the slot to the nozzle, and (2) a screen within the slot that includes holes sized for allowing passage of air while filtering passage of liquid and projectiles, whereby upon a person blowing air through the filtered blower, candles are extinguished while liquid and projectiles are prevented from reaching the dessert.

In another embodiment, the filtered blower includes a plurality of body sections adjoined to each other along their length to form the body that is substantially hollow. In one embodiment, the plurality of body sections are exactly two body sections.

In one embodiment, the body sections are plastic. In another embodiment the body sections are polystyrene. In yet another embodiment, the body sections are adjoined via welding.

In one embodiment, the screen is welded to the slot.

In another embodiment, the first portion of the body has a cross-section opening that substantially corresponds to the dimensions of the screen.

In one embodiment, the second portion of the body has a length that is less than ⅔ of the length of the body. In another embodiment, the mouthpiece has a width less than half of the body length.

According to another embodiment, a filtered blower for extinguishing candles on a desert, such as a birthday cake and the like, is provided. The filtered blower includes (1) a substantially tubular body that includes (a) a plurality of body sections adjoined to each other along their length to form a substantially hollow space, a mouthpiece, and a nozzle, (b) a raised lip surrounding the mouthpiece, and (c) a slot within the body between the mouthpiece and nozzle, having a first and second portion, wherein the first portion retains substantially unchanged dimensions, and the second portion narrows distally from the slot to the nozzle, and (2) a screen within the slot, including holes sized for allowing passage of air while filtering passage of liquid and projectiles, whereby upon a person blowing air through the filtered blower, candles are extinguished while liquid and projectiles are prevented from reaching the dessert.

Other systems, methods, features and advantages of the present invention will be or become apparent to one with skill in the art upon examination of the following drawings and detailed description. It is intended that all such additional systems, methods, features and advantages be included within this description and be within the scope of the present disclosure.

### BRIEF DESCRIPTION OF THE DRAWINGS

The above-mentioned features will become more clearly understood from the following detailed description read together with the drawings in which:

FIG. 1 is an exploded view of an embodiment of a filtered blower for extinguishing birthday cake candles.

FIG. 2 is a perspective view of the filtered blower of FIG. 1.

FIG. 3 is an end view from the mouthpiece of the filtered blower of FIG. 2;

FIG. 4 is an end view from the exhaust of the filtered blower of FIG. 2;

FIG. 5 is a cutaway view of a body section of the filtered blower of FIG. 2;

FIG. 6 is a front view of an exemplary filter for the filtered blower of FIG. 2;

FIG. 7 is a side view of an exemplary filter for the filtered blower of FIG. 2; and

FIG. 8 is an illustration of a person using the filtered blower to extinguish the candles on a birthday cake.

### DETAILED DESCRIPTION

A filtered blower for extinguishing birthday candles is disclosed. In particular, the filtered blower includes a filter for protecting a cake or other desert from moisture, projectiles, and other expectorants that proceed from the mouth of the person blowing out the candles.

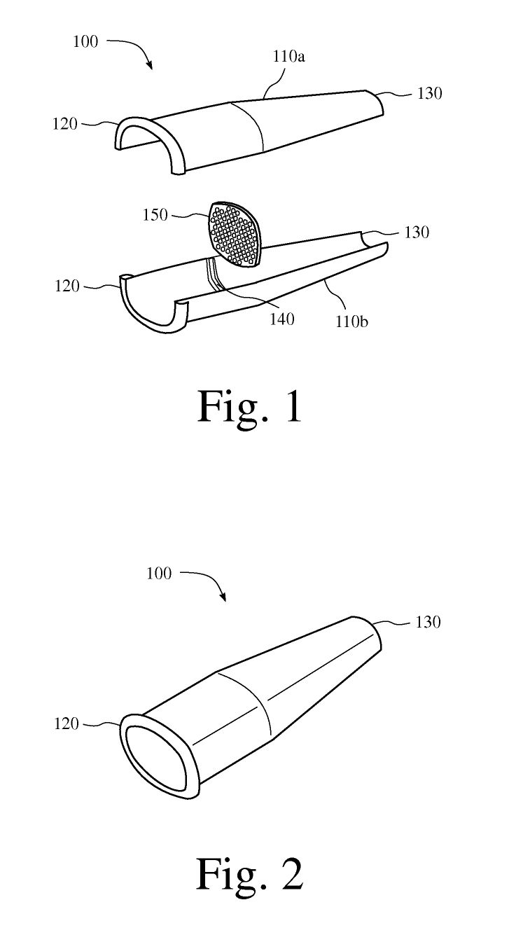

FIG. 1 is an exploded view of one embodiment of a filtered blower 100 for extinguishing birthday cake candles. FIG. 2 is a perspective view of the filtered blower 100. The filtered blower 100 includes a body 110 and a screen 150. In one embodiment, two body sections 110a, 110b are adjoined to form a generally tubular and substantially hollow body 110. The screen 150 fits between the body sections 110a, 110b into a slot 140. The slot 140 is grooved so that the screen 150 fits into the slot 140 and filters substantially the entire cross section of the body 110. Each body section 110a, 110b includes a slot 140 for the screen 150. The screen 150 fits within the slots 140 of each body section 110a, 110b so that the screen 150 does not become dislodged.

The body 110 includes a raised lip 120 at one end of the body 110. Each body section 110a, 110b includes a raised lip 120. With the body sections 110a, 110b adjoined, the raised lip 120 encircles the larger end of the body 110. The raised lip 120 at the large end of the body 110 corresponds to the mouthpiece of the filtered blower 100. The mouthpiece end of the body 110 is larger than the exhaust or nozzle 130 at the opposite end of the body 110.

Those of skill in the art will readily appreciate that the body 110 may include any number of body sections adjoined to adjacent body sections to form a generally tubular and substantially hollow body 110 for the filtered blower 100.

The filtered blower 100 is used by placing the mouth upon the mouthpiece end, with the raised lip 120. The raised lip 120 provides for improved grip between the teeth or lips of the user. The user blows air into the filtered blower 100 at the mouthpiece end, through the screen 150, and the air exits through the nozzle 130.

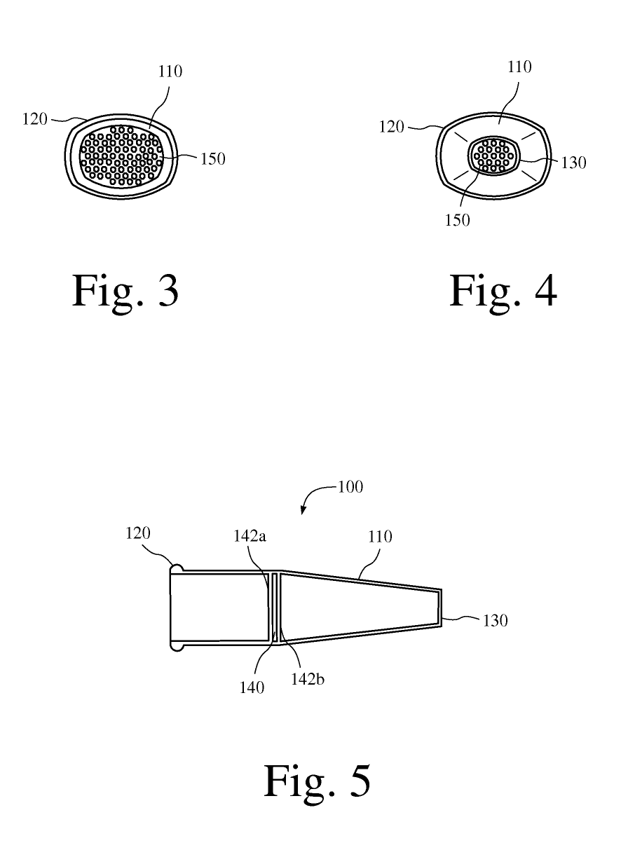

FIG. 3 is an end view from the mouthpiece of the filtered blower 100. The raised lip 120 is the large end of the filtered blower 100. The body 110 narrows from the raised lip 120 through the opening toward the screen 150. The screen 150 is lodged within the body 110 between the body sections 110a, 110b and forms a cross section that filters the entirety of the opening within the body 110.

FIG. 4 is an end view from the nozzle 130 of the filtered blower 100. The body 110 of the filtered blower 100 increases in size moving distally from the nozzle 130 toward the raised lip 120. The screen 150 is partially visible from the nozzle 130 of the body 110.

In one embodiment, the filtered blower 100 has a shape resembling a slightly flattened ellipse. That is, when viewed from either end, the filtered blower 100 generally resembles and ellipse that is slightly flattened from each of its four sides. The width of the filtered blower 100 is slightly more than its height at the mouthpiece end, so that the mouthpiece opening conforms generally to a human mouth. In one embodiment, the width is greater than one inch while the height is less than one inch. In one embodiment, the width of the raised lip is approximately 1.15 inches and the height of the raised lip is approximately 0.86 inches. Those of skill in the art will readily appreciate that the dimensions can be varied without departing from the spirit or scope of the present invention.

FIG. 5 is a cutaway view of a body section 110a, 110b of the filtered blower 100. Each a, 110b section 110 includes a raised lip 120, a nozzle 130, and a slot 140. The width or diameter of each body section 110a, 110b is substantially unchanged from the mouthpiece end at the raised lip 120 to the slot 140. The width or diameter of each body section 110a, 110b narrows from the slot 140 to the nozzle 130.

Two walls 142a, 142b extend from one edge of the body section 110a, 110b to the opposite edge. The walls 142a, 142b are located at the portion where the body section 110a, 110b begins to narrow toward the nozzle 130. The walls 142a, 142b are spaced a sufficient distance apart so that the screen 150 lodges securely between the walls 142a, 142b. Each body section 110a, 110b includes two walls 142a, 142b so that the screen 150 is lodged securely between the walls 142 and the body sections 110a, 110b.

In some embodiments, the length of the filtered blower 100 is more than twice the width at the mouthpiece end. In one embodiment, the length of the filtered blower is approximately 2.75 inches, and the width of the raised lip 120 is approximately 1.15 inches.

Each body section 110a, 110b narrows from the slot 140 to the nozzle 130. This narrowing increases the force of the air that is blown through the filtered blower 100. In one embodiment, the width of each body section 110a, 110b is less than one inch at the slot 140 and narrows to less than one-half inch at the nozzle 130.

The length of the narrowing portion of the body section 110a, 110b is typically less than ⅔ the length of the entire body section 110a, 110b. In one embodiment, the narrowing portion of the body section 110a, 110b is approximately 7/11 of the length of the filtered blower 100.

In some embodiments, each body section 110a, 110b is made from plastic. In one such embodiment, each body section 110a, 110b is made from high impact polystyrene. Pure polystyrene is a colorless and hard plastic having limited flexibility. Polystyrene can be cast into molds with sufficient detail for the inside and outside specifics of the filtered blower 100. Though polystyrene can be transparent, it can also be made to take on color. The filtered blower 100 is typically colored to match birthday celebration items.

In one embodiment, each body section 110a, 110b is welded to the adjacent body section 110a, 110b along each entire adjoining edge. That is, for a filtered blower 100 made from two body sections 110a, 110b, the two edges of body section 110a are welded along the entirety of each edge to the two corresponding edges of the opposing body section 110b. Welding along the entirety of the edges prevents air leakage when a user is blowing air through the filtered blower 100.

In one embodiment, each body section 110a, 110b is welded to an adjacent body section 110a, 110b via ultrasonic welding. Ultrasonic welding is sometimes referred to as sonic welding. High frequency (15 kHz to 40 kHz) low amplitude vibration creates heat via friction between the adjacent body sections 110a, 110b. The energy is concentrated for maximum weld strength between the interface of the two surfaces. Ultrasonic welding is the fastest heat sealing technology available and can be used on most plastic materials.

In another embodiment, adjacent body sections 110a, 110b are welded via solvent welding. In such an embodiment, a solvent is applied to temporarily dissolve the polymer, typically at room temperature. The polymer chains of the two materials are free to move within the liquid and mingle with similarly dissolved polymer chains in the other material. After a sufficient time, the solvent permeates through the polymer so that the polymer chains lose their mobility. A solid mass of entangled polymer chains remains forming a solvent weld.

Those of skill in the art will readily appreciate that other welding methods are also appropriate for joining the adjacent sections 110 to form the filtered blower 100.

In one embodiment, the screen 150 is welded into the slot 140 of each body section 110a, 110b as the filtered blower 100 is assembled. That is, the screen 150 is welded to the body 110. In one such embodiment, the screen 150 is welded to each body section 110a, 110b via ultrasonic welding. In another embodiment, the screen 150 is welded to each body section 110a, 110b via solvent welding. Those of skill in the art will readily appreciate that other welding methods are also appropriate for joining the screen 150 with the body sections 110a, 110b to form a filtered blower 100. Welding the screen 150 to the slots 140 within each section 110a, 110b securely lodges the screen 150 within the filtered blower 100. Welding the screen 150 to the inside of the filtered blower 100 reduces the possibility of the screen 150 becoming dislodged during use. That is, when air is blown through the filtered blower 100, the screen 150 is more likely to remain in place and to perform its intended function of filtering liquid from the breath stream of the user.

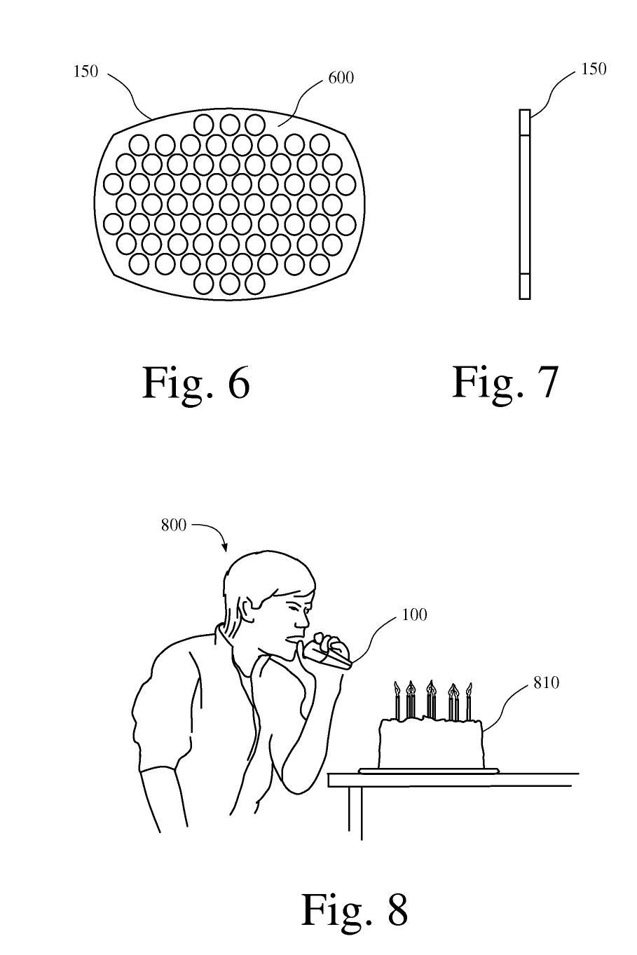

FIG. 6 is a front view of an exemplary screen 150 for the filtered blower 100. FIG. 7 is a side view of an exemplary screen 150 for the filtered blower 100. The screen 150 includes openings or holes 160 throughout. In one embodiment, the screen 150 is made from plastic. In one such embodiment the screen 150 is made from high impact polystyrene. As a person blows air through the filtered blower 100 the screen 150 filters any liquid from their breath stream while also allowing the air to pass through.

In the illustrated embodiment, the holes 160 are circular and spaced in a diamond pattern. That is, four holes 160 form the shape of a diamond. The holes 160 are sized to allow air blown from the mouth of a person to pass through while filtering moisture, projectiles, and other expectorants that proceed from the mouth of the person. In the illustrated embodiment, each hole is approximately 0.066 inches in diameter. Those of skill in the art will readily appreciate that other sizes, shapes, and/or patterns may be used for the holes 160 within the screen 150 without departing from the spirit or scope of the present invention.

FIG. 8 is an illustration of a person using the filtered blower 100 to extinguish the candles on a birthday cake. The person blows air into the filtered blower 100 at the mouthpiece end, through the screen 150, and the air exits through the nozzle 130. The person may secure the filtered blower 100 within their teeth or lips via the raised lip 120 at the mouthpiece end of the filtered blower 100.

The filtered blower 100 includes various functions. The function of filtering liquid from the air stream of a user is implemented, in one embodiment, by a screen 150.

According to one embodiment of the present invention, a filtered blower 100 for extinguishing candles on a dessert, such as a birthday cake, is provided. The filtered blower 100 includes (1) a generally tubular body including (a) a mouthpiece with a first opening surrounded by a raised lip, (b) a nozzle having a second opening that is smaller than the first opening, and (c) a slot within the body between the mouthpiece and the nozzle, with a first portion and a second portion, wherein the first portion retains substantially unchanged dimensions, and the second portion narrows distally from the slot to the nozzle, and (2) a screen within the slot that includes holes sized for allowing passage of air while filtering passage of liquid and projectiles, whereby upon a person blowing air through the filtered blower, candles are extinguished while liquid and projectiles are prevented from reaching the dessert.

In another embodiment, the filtered blower 100 includes a plurality of body sections adjoined to each other along their length to form the body that is substantially hollow. In one embodiment, the plurality of body sections are exactly two body sections.

In one embodiment, the body sections are plastic. In another embodiment the body sections are polystyrene. In yet another embodiment, the body sections are adjoined via welding.

In one embodiment, the screen is welded to the slot.

In another embodiment, the first portion of the body has a cross-section opening that substantially corresponds to the dimensions of the screen.

In one embodiment, the second portion of the body has a length that is less than ⅔ of the length of the body. In another embodiment, the mouthpiece has a width less than half of the body length.

According to another embodiment, a filtered blower 100 for extinguishing candles on a desert, such as a birthday cake and the like, is provided. The filtered blower 100 includes (1) a substantially tubular body that includes (a) a plurality of body sections adjoined to each other along their length to form a substantially hollow space, a mouthpiece, and a nozzle, (b) a raised lip surrounding the mouthpiece, and (c) a slot within the body between the mouthpiece and nozzle, having a first and second portion, wherein the first portion retains substantially unchanged dimensions, and the second portion narrows distally from the slot to the nozzle, and (2) a screen within the slot, including holes sized for allowing passage of air while filtering passage of liquid and projectiles, whereby upon a person blowing air through the filtered blower, candles are extinguished while liquid and projectiles are prevented from reaching the dessert.

From the foregoing description, it will be recognized by those skilled in the art that a filtered blower 100 for protecting a cake or other desert from moisture, projectiles, and other expectorants that proceed from the mouth of the person blowing out the candles has been provided

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A filtered blower for extinguishing candles on a dessert, said filtered blower comprising:
a generally tubular body, the body including:
a mouthpiece having a first opening surrounded by a raised lip;
a nozzle having a second opening that is smaller than said first opening; and
a slot within the body, said slot between said mouthpiece and said nozzle, wherein said body has a first portion and a second portion, wherein said first portion retains substantially unchanged dimensions, and wherein said second portion narrows distally from said slot to said nozzle; and
a screen within said slot, the screen including holes sized for allowing passage of air while filtering passage of liquid and projectiles;
whereby upon a person blowing air through the filtered blower, candles are extinguished while liquid and projectiles are prevented from reaching the dessert.

2. The filtered blower of claim 1, further comprising a plurality of body sections adjoined to each other along their length to form said body, wherein said body is substantially hollow.

3. The filtered blower of claim 2, wherein said plurality of body sections are exactly two body sections.

4. The filtered blower of claim 2, wherein said body sections are plastic.

5. The filtered blower of claim 4, wherein said body sections are polystyrene.

6. The filtered blower of claim 2, wherein said body sections are adjoined via welding.

7. The filtered blower of claim 1, wherein said screen is welded to said slot.

8. The filtered blower of claim 1, wherein said first portion of said body has a cross-section opening that substantially corresponds to dimensions of said screen.

9. The filtered blower of claim 1, wherein said second portion has length that is less than ⅔ of length of said body.

10. The filtered blower of claim 1, wherein said mouthpiece has a width less than half of length of said body.

11. A filtered blower for extinguishing candles on a dessert, said filtered blower comprising:
a substantially tubular body, the body including:
a plurality of body sections adjoined to each other along their length to form a substantially hollow space, a mouthpiece, and a nozzle;
a raised lip surrounding said mouthpiece; and
a slot within the body, said slot between said mouthpiece and said nozzle, wherein said body has a first portion and a second portion, wherein said first portion retains substantially unchanged dimensions, and wherein said second portion narrows distally from said slot to said nozzle; and
a screen within said slot, the screen including holes sized for allowing passage of air while filtering passage of liquid and projectiles;
whereby upon a person blowing air through the filtered blower, candles are extinguished while liquid and projectiles are prevented from reaching the dessert.

12. The filtered blower of claim 11, wherein said plurality of body sections are exactly two body sections.

13. The filtered blower of claim 11, wherein said body sections are plastic.

14. The filtered blower of claim 13, wherein said body sections are polystyrene.

15. The filtered blower of claim 11, wherein said body sections are adjoined via welding.

16. The filtered blower of claim 11, wherein said screen is welded to said slot.

17. The filtered blower of claim 11, wherein said first portion of said body has a cross-section opening that substantially corresponds to dimensions of said screen.

18. The filtered blower of claim 11, wherein said second portion has length that is less than ⅔ of length of said body.

19. The filtered blower of claim 11, wherein said mouthpiece has a width less than half of length of said body.
